(19) United States
(12) Patent Application Publication
(10) Pub. No.: US 2019/0083214 A1
(43) Pub. Date: Mar. 21, 2019

(54) DENTAL FLOSS HOLDER

(71) Applicant: STAR FLOSS AS, Oslo (NO)

(72) Inventor: Kevin Hermansen, Oslo (NO)

(73) Assignee: STAR FLOSS AS, Oslo (NO)

(21) Appl. No.: 16/074,957

(22) PCT Filed: Jan. 26, 2017
(86) PCT No.: PCT/EP2017/051598

§ 371 Date: Aug. 2, 2018

(30) Foreign Application Priority Data
Feb. 2, 2016 (NO) 20160160

(51) Int. Cl. A61C 15/04

(52) U.S. Cl. CPC A61C 15/046

(57) ABSTRACT

A dental floss holder includes a longitudinal connecting element, a first support plate, a second support plate, and at least four lengths of dental floss. The longitudinal connecting element includes a first end and a second end. The first support plate is arranged at the first end of the longitudinal connecting section, and has a first circumference. The second support plate is arranged at the second end of the longitudinal connecting section, opposite the first support plate, and has a second circumference. The first and second circumference are arranged such that each of the at least four lengths of dental floss is arranged on the dental floss holder and each of the at least four lengths of dental floss extends from the first circumference to the second circumference.

### FIELD OF THE INVENTION

The present invention concerns a dental floss holder, and more particularly a dental floss holder not requiring the use of hands for flossing.

### BACKGROUND

In the prior art, dental flossing requires the use of fingers to hold the dental floss, and/or a device comprising a dental floss holder and a handle for guiding the dental floss holder in the mouth of a user. A common problem or disadvantage connected with prior art methods of dental flossing is that the person flossing have to use one or both of his hands, and is thus prevented from performing other tasks, such as driving, while flossing. A further potential disadvantage is that the flossing is done with the mouth at least partially open, and this may in some settings be socially unacceptable. Another disadvantage with regular “open mouth flossing” is that the flossing action often produces projectiles of food residues and saliva that is best seen on the bathroom mirror after use.

Examples of typical prior art dental floss holders requiring a handle for guiding the dental floss holder in the mouth of a user are disclosed in U.S. Pat. Nos. 4,404,978 and 3,106,216.

An example of a replaceable dental floss holder for attachment to a separate handle for guiding the dental floss holder in the mouth of a user is disclosed in U.S. Pat. No. 2,180,522.

WO 2015/197616 A1 discloses a dental floss holder, where a user may floss his teeth without using his hands. The dental floss holder comprises multiple arms between which dental floss is arranged to form a polyhedron-like structure.

The dental floss holder disclosed in WO 2015/197616 A1 solves many of the potential problems and/or disadvantages of the prior art methods and devices for flossing by providing a dental floss holder not requiring the use of hands. However, during testing of dental floss holders as described in WO 2015/197616 A1 some potential disadvantages or problems were discovered. The goal of the present invention is to provide a dental floss holder which alleviates or avoids at least some of said problems and/or disadvantages.

### SUMMARY OF THE INVENTION

The present invention provides a dental floss holder which does not require the use of a handle or fingers, to guide the dental floss in the mouth of a user, as well as a method of manufacturing said dental floss holder. The present invention is defined by the appended claims and in the following:

In a first aspect, the present invention provides a dental floss holder comprising a longitudinal connecting element, a first support plate and a second support plate, wherein
the longitudinal connecting element comprises a first end and a second end;
the first support plate is arranged at the first end of the longitudinal connecting section and has a first circumference;
the second support plate is arranged at the second end of the longitudinal connecting section, opposite the first support plate, and has a second circumference; and
the first and the second circumference are arranged such that at least four lengths of dental floss may be arranged on the dental floss holder, each length of dental floss extending from the first circumference to the second circumference.

Each length of dental floss may also be defined as extending from a separate position at the first circumference to a separate position at the second circumference.

Each of the lengths of dental floss is arranged at a distance from the connecting element such that each length may be inserted between a pair of teeth.

In one embodiment of the dental floss holder, each of the at least four lengths of dental floss may be arranged in parallel to the centerline of the longitudinal connecting element.

In one embodiment of the dental floss holder, each of the at least four lengths of dental floss may be arranged on an opposite side of the longitudinal connecting element in relation to one of the other at least four lengths of dental floss.

In one embodiment of the dental floss holder, the centerline of the longitudinal connecting element is perpendicular to the plane of the first support plate and the second support plate.

In one embodiment of the dental floss holder, the centerline of the longitudinal connecting element intersects the center of symmetry of the first support plate and the second support plate, respectively.

In one embodiment of the dental floss holder, each of the first support plate and the second support plate comprises a first surface and a second surface, the first surface of the first support plate and the second support plate is connected to the first and second end of the longitudinal connecting element, respectively, and the second surfaces comprises fastening means for dental floss.

In one embodiment of the dental floss holder, the fastening means for dental floss comprises a lid element arranged to releasably fasten a string of dental floss at the second surface. Preferably, the string of dental floss is fastened by clamping, screwing or otherwise connecting the lid to the second surface.

In one embodiment of the dental floss holder, the first and the second circumference have a substantially circular or elliptic shape.

In one embodiment of the dental floss holder, each of the first and the second circumference comprises at least four recesses for accommodating the at least four strings of dental floss. The recesses are deep enough to keep the strings of dental floss in place. The recesses extend less than 50% of the distance from the circumference to the center of the support plate, preferably less than 25%, and most preferred less than 10%.

In one embodiment of the dental floss holder, the at least four strings of dental floss may be arranged in a first and a second pair, each pair comprising two strings of dental floss arranged on opposite sides of the longitudinal connecting element, and the distance from longitudinal connecting element to the two strings of dental floss in the first pair is larger than the corresponding distance to the second pair.

In one embodiment of the dental floss holder the longitudinal connecting element is hourglass-shaped.

In one embodiment of the dental floss holder, the at least four lengths of dental floss are non-releasably fastened at the first and the second circumference.

In another embodiment of the dental floss holder according to the invention, the first and second circumferences are made up of rounded surfaces. The rounded surfaces ensure that the dental floss holder is comfortable to have in the mouth by avoiding any sharp edges which may hurt or scratch the gums or palate.

In another embodiment of the dental floss holder according to the invention, the length of dental floss is fastened to the fastening portion by any suitable means, such as by molding, melting, embedding, gluing, winding, tying or clamping.

In another embodiment of the dental floss holder according to the invention, at least two lengths of dental floss are aligned and arranged on opposite sides of the longitudinal connecting element.

In yet another embodiment of the dental floss holder, each of the first support plate and the second support plate comprises at least one through-going opening. The through-going openings having a cross-sectional area large enough to prevent choking if the dental floss holder accidentally is stuck in the throat of a user. The through-going openings may also be defined as extending from the first surface to the second surface of the respective support plate. The cross-sectional area of the through-going hole being large enough to satisfy the relevant national and international safety standard—

In a second aspect, the present invention provides a method of manufacturing a dental floss holder according to the first aspect, comprising the steps of:
a. molding at least two connectable dental floss holder elements, each of the dental floss holder elements comprises a section of the first support plate, a section of the second support plate, a section of the longitudinal connecting element and two lengths of dental floss arranged on opposite sides of the section of the longitudinal connecting element;
b. assembling the at least two dental floss holder elements to provide the dental floss holder.

In one embodiment of the method of manufacturing, step a) comprises molding at least one intermediate dental floss holder element comprising a section of the first support plate, a section of the longitudinal connecting element and a section of the second support plate, wherein two lengths of dental floss are arranged on opposite sides of the third section of the longitudinal connecting element

In one embodiment of the method of manufacturing, the number of connectable dental floss holder elements is equal to half the number of lengths of dental floss in the dental floss holder.

In one embodiment of the method of manufacturing, one of the at least two connectable dental floss holder elements comprises a main section of the first support plate and a minor section of the second support plate, and one of the at least two connectable dental floss holder elements comprises a minor section of the first support plate and a main section of the second support plate.

In one embodiment of the method of manufacturing, step a) comprises molding at least three connectable dental floss holder elements, wherein one of the at least three connectable dental floss holder elements comprises a minor section of the first support plate, a section of the longitudinal connecting element and a minor section of the second support plate.

In further embodiments, the dental floss holder comprises at least six lengths of dental floss or at least eight lengths of dental floss.

For all embodiments, the distance between a length of dental floss and an outer surface of the longitudinal connecting element should be sufficient to allow the length of dental floss to pass between two adjacent teeth and touch the upper surface of the gum between said teeth.

In another embodiment of the dental floss holder according to the invention, a compressible material is arranged in the space between the lengths of dental floss and the longitudinal connecting element, such that the compressible material will help to push the lengths of dental floss back out once inserted between adjacent teeth.

The term “support plate” is intended to comprise any plate shaped design having a continuous circumference suitable for arranging the string of dental floss. The circumference is preferably circular, elliptic, square, pentagonal, hexagonal, or octagonal. The presence of small recesses/grooves for accommodating lengths of dental floss should not be construed as having an influence on the overall shape of the circumference, i.e. the circumference is considered circular even if the circumference is interrupted by a number of grooves/recesses for dental floss.

The term “hourglass-shaped” is intended to mean that the longitudinal connecting element comprises a flared section at each end. In other words, two end sections of the longitudinal connecting element, the end sections comprising the first and second end, respectively, has a transverse cross-sectional area which increases in a direction towards the respective ends. The two end sections may be connected by a non-flared/straight section and still provide a longitudinal connecting element considered to be hourglass-shaped within the meaning of the present specification.

### SHORT DESCRIPTION OF THE DRAWINGS

Embodiments of the present invention are described in detail by reference to the following drawings:

FIG. 1 is a perspective view of a first embodiment of a dental floss holder according to the invention.

FIG. 2 is a front view of the first embodiment of the dental floss holder according to the invention.

FIG. 3 is a perspective view of a second embodiment of the invention of a dental floss holder according to the invention.

FIG. 4 is a perspective view of a third embodiment of a dental floss holder according to the invention.

FIG. 5 is a perspective view illustrating a method of manufacturing a dental floss holder.

FIGS. 6-8 are perspective views illustrating the method of manufacturing in FIG. 5.

FIG. 9 is a perspective view of a dental floss holder according to the invention, obtained by the method of FIG. 5.

### DETAILED DESCRIPTION OF EMBODIMENTS OF THE INVENTION

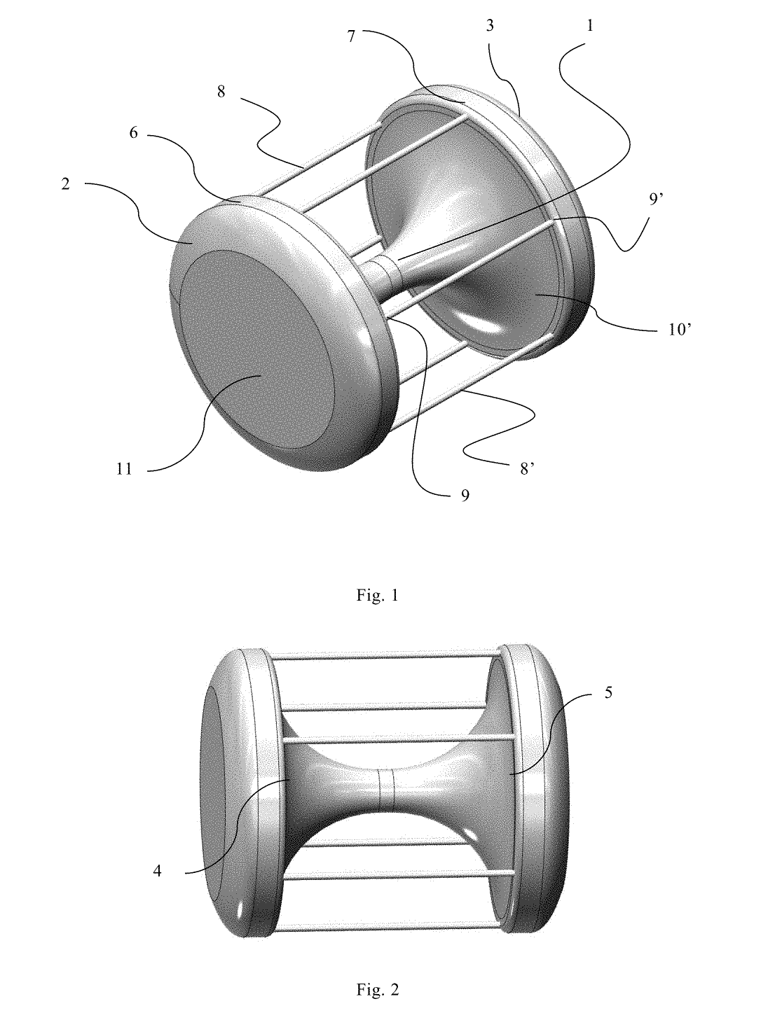

A first embodiment of a dental floss holder according to the invention is disclosed in FIG. 1. The dental floss holder comprises a first support plate 2 and a second support plate 3 interconnected by a longitudinal connecting element 1 (may also be described as a connecting shaft or axle). The connecting element 1 comprises a first end 4 and a second end 5 (shown in FIG. 2). The first support plate 2 is arranged at the first end 4 of the connecting section and the second support plate 3 is arranged at the second end 5. In this embodiment, both the first and the second support plate have a circular circumference 6, 7. The connecting section is connected at the center of the first surface 10′, 10 of the support plates 2, 3. Six lengths (or strings) of dental floss are arranged extending from the first support plate to the second support plate. Each of the lengths of dental floss 8, 8′ extend from the first support plate 2 to the second support plate 3. The support plates provide a highly rigid structure, especially when combined with the hourglass-shaped connecting element 1. In addition, the lengths of dental floss are arranged such that each individual length of dental floss 8 has a cooperating length of dental floss 8′ (cooperating in the sense that each length is able to be inserted between opposing sets of adjacent teeth at the same time) arranged on the opposite side of the connecting section (i.e. the two lengths of dental floss forming a pair). In use, the two opposing lengths of dental floss (i.e. the pair) will contribute to neutralize or minimize the forces applied to the structure of the dental holder, such as bending forces on the connecting section and/or on the plate elements. This effect is provided as a consequence of using the support plates which are able to distribute or balance the forces applied on the two opposing lengths of dental floss. The ends of each length of dental floss are fastened and/or arranged at a separate position 9, 9′ close to, and/or at, the circumference of the first and second support plates 2, 3, respectively. Each of the six lengths of dental floss is arranged at a distance from, and in parallel to the centerline of, the connecting element, such that each length may be inserted between a pair of adjacent teeth. If desired, a dental holder as shown in FIG. 1 may be used repeatedly and should then be rinsed/cleaned after each use. By using support plates the dental holder is easily rinsed off to remove any residues attached to the dental holder after use. Further, the dental holder provides a smooth and comfortable use in the mouth with no edges sticking out.

Advantageously, each of the first support plate and the second support plate comprises at least one through-going opening (not shown). The through-going openings have a total cross-sectional area large enough to prevent choking if the dental floss holder accidentally is stuck in the throat of a user

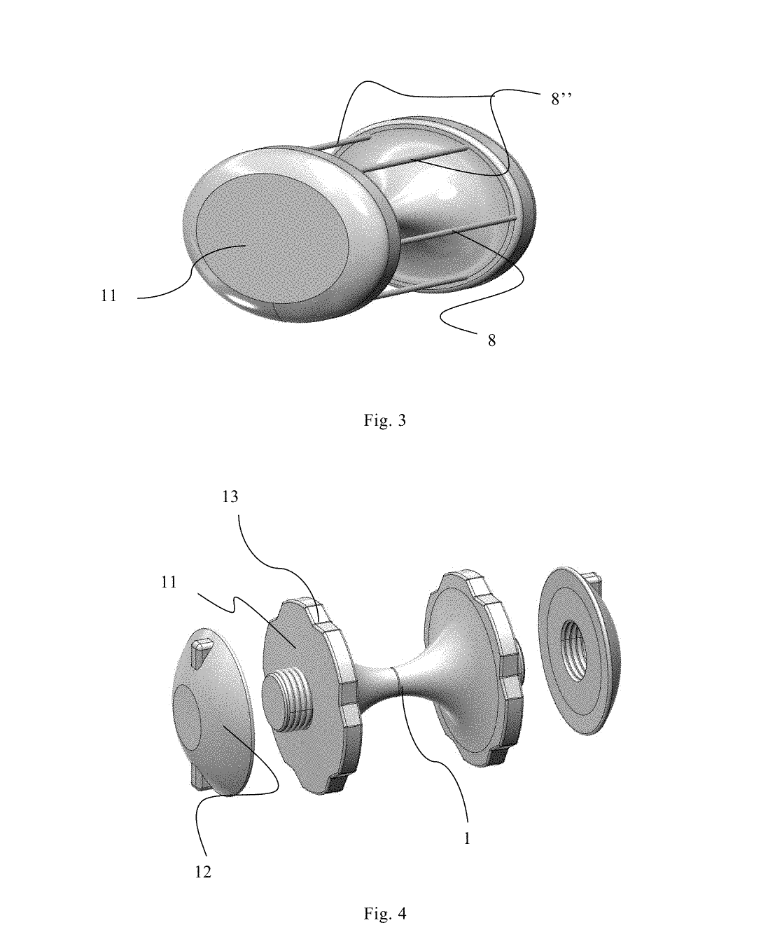

The required distance between a length of dental floss and the connecting section may differ depending on the type of teeth being cleaned and the user. FIG. 3 shows an embodiment intended to avoid increasing the size of the dental floss holder, while still providing for the ability to vary the distance between a length of dental floss and the connecting section. This is achieved by using support plates having an elliptic circumference. In FIG. 3, the dental holder features two opposing lengths of dental floss 8 arranged on opposite sides of the major axis of the elliptic circumference (only one is visible in the drawing), while the remaining lengths of dental floss 8″ are arranged along the circumference between its major axis and minor axis. In this manner a larger distance from the connecting element is obtained for the lengths of dental floss arranged at the major axis. A similar result may be obtained by use of a dental floss holder similar to the one in FIG. 1, wherein the connecting element is connected to the support plates off-center. However, such a solution is not ideal since a pair of opposing lengths of dental floss will not have the same distance to the connecting element.

The dental floss holders in FIGS. 1, 2 and 3 features permanently fastened or integrated lengths of dental floss, i.e. the lengths are molded/melted/glued in place.

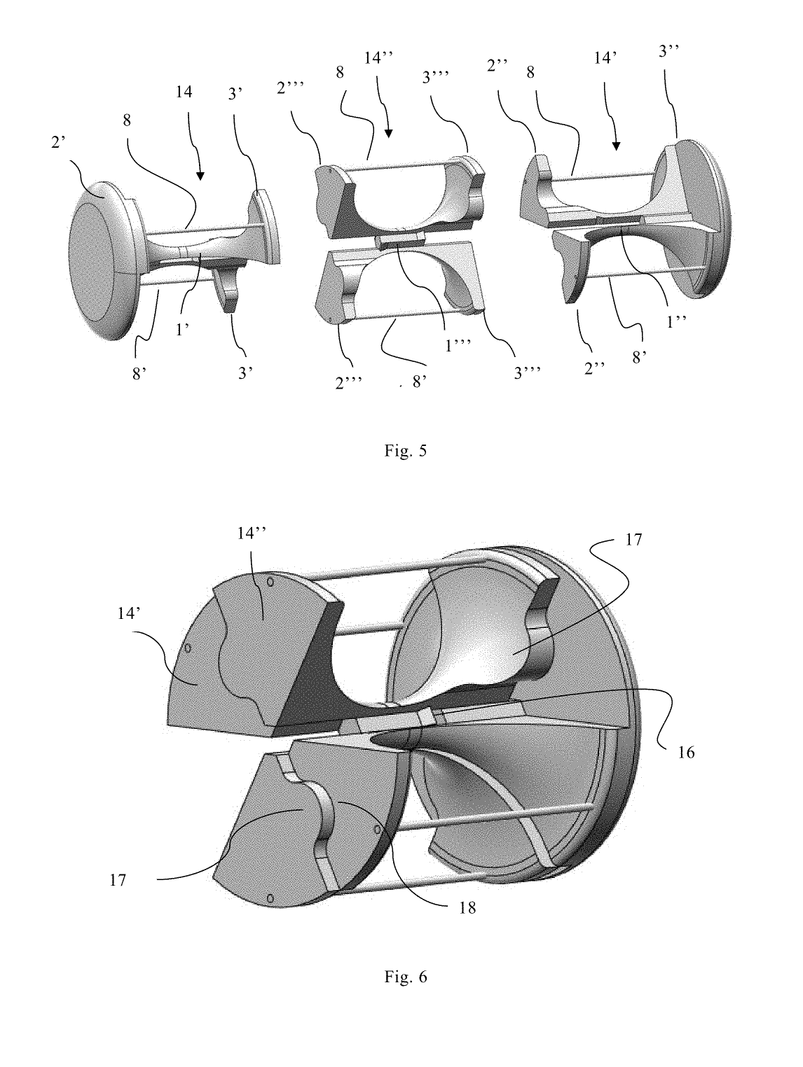

FIG. 4 shows an embodiment of the dental holder, wherein the lengths of dental floss may be replaced. The dental floss holder comprises fastening means for fastening the lengths of dental floss onto the outer surface of the support plates (i.e. the second surface of the support plates). In this particular embodiment, the fastening means comprises a lid 12 which may be screwed onto the outer surface such that the dental floss may be fastened between the lid and the outer surface. Alternate fastening means may for instance include a similar lid, wherein the lid is held against the outer surface by a clamp function or click lock system, a conical tap that the string is winded around, or any other type of arrangement suitable for fastening dental floss. In embodiments wherein the lengths of dental floss may be replaced, the circumference of the support plates will preferably comprise grooves or recesses 13 for accommodating the lengths of dental floss and keeping them at the correct position along the circumference of the support plates.

The ability to fasten and unfasten the strings of dental floss provides additional advantages to the user:
re-usable, the dental floss holder can now be used multiple times, even if the strings of dental floss are frayed;
the amount of dental floss used is significantly decreased compared to traditional finger flossing where most of the dental string is wrapped around the fingers; and
the user is able to use his favorite brand of dental floss.

The production of relatively complicated structures by molding may be simplified by manufacturing the overall structure in multiple pieces. The traditional and potentially automated injection molding process includes an injection mold (A plate) and an ejector mold (B plate) that comes together to form the cavity that is filled with the molding material under pressure/heat. The string of dental floss is a foreign component that can be molded in place between plate A and plate B. However, a maximum of two strings can be molded in place at the same time since they are in the plane of the intersecting surface of the two plates. For a 4 string dental floss holder, 2 planes are required and for a 6 string dental floss holder, 3 planes are required. By separating the body into several pieces that can later be assembled, the traditional and simple injection molding process can be used.

A method of manufacturing and assembling a dental floss holder according to the invention is illustrated in FIG. 5. In this particular embodiment, the dental floss holder features six lengths of dental floss, and to facilitate the molding process, three separate dental floss holder elements 14, 14′, 14″ are required, i.e. one dental floss element per set/pair of opposing lengths of dental floss. Thus, a similar embodiment, featuring four lengths of dental floss would only require two separate dental holder elements.

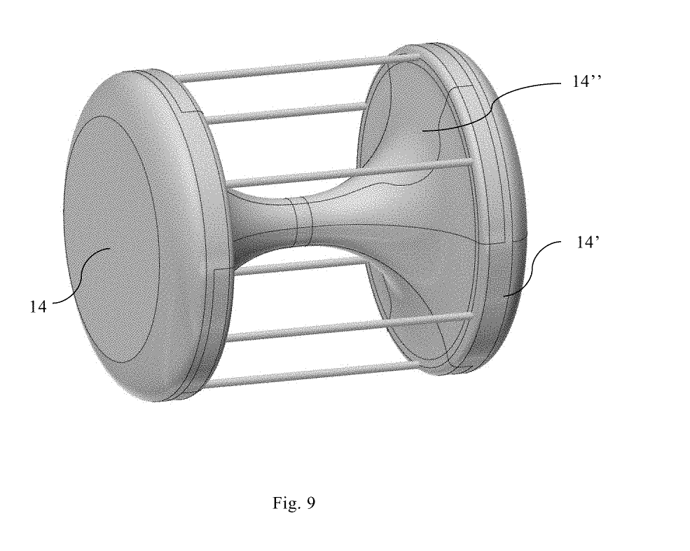

In the manufacture of the specific embodiment shown in FIG. 9, three dental floss holder elements 14, 14′, 14″ are molded separately to provide
a first dental floss holder element 14 comprising a main section of the first support plate 2′, a first section of the longitudinal connecting element 1′ and a minor section of the second support plate 3′, wherein two lengths of dental floss 8,8′ are arranged on opposite sides of the first section of the longitudinal connecting element;
a second dental floss holder element 14′ comprising a minor section of the first support plate 2″, a second section of the longitudinal connecting element 1″ and a main section of the second support plate 3″, wherein two lengths of dental floss 8, 8′ are arranged on opposite sides of the second section of the longitudinal connecting element; and
an intermediate dental floss holder element 14″ comprising a minor section of the first support plate 2′″, a third section of the longitudinal connecting element 1′″ and a minor section of the second support plate 3′″, wherein two lengths 8, 8′ of dental floss are arranged on opposite sides of the third section of the longitudinal connecting element.

Due to the symmetry of the dental floss holder shown in FIG. 9, the two dental floss holder elements 14, 14′ are identical. However, in other embodiments the dental floss holder elements 14, 14′ may be different from each other.

After molding, the three dental floss holder elements 14, 14′, 14″ are assembled. In FIG. 6, the second dental floss holder element 14′ and the intermediate dental floss holder element 14″ are shown during connection. To provide the dental floss holder of FIG. 9, the first dental floss holder element 14 is then connected to the other two assembled elements 14′ and 14″ (this step is not shown).

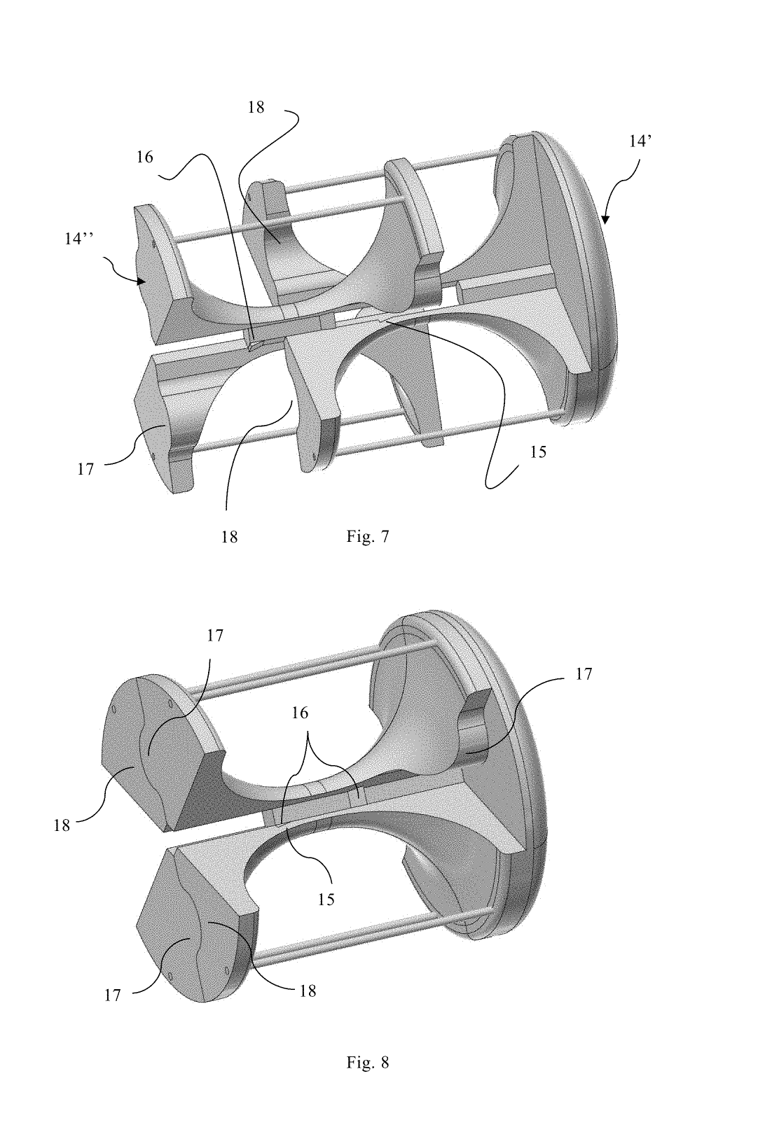

The second and intermediate dental floss holder elements comprise cooperating locking means for locking/fastening the two elements together in the axial direction. In this embodiment, the locking means comprises a click system featuring a recess 15 and a cooperating locking wedge 16, see FIGS. 6-8. The first dental floss holder has identical locking means. To further strengthen the connection between the dental floss holder elements in the radial direction, they are also provided with ribs 17 and cooperating grooves 18. In FIGS. 7 and 8, the intermediate and second dental floss holder elements are shown for illustrative purposes of the locking mechanisms.

As described, in this particular embodiment, the dental floss holder elements are constructed to allow an assembly not requiring adhesive or melting. However, in other embodiments, the locking means may advantageously be replaced by use of any suitable type of adhesive or similar.

The illustrated method provides a dental floss holder featuring six lengths of dental floss, thus requiring three dental floss holder elements. However, in an embodiment comprising only four lengths of dental floss, the dental floss holder may be manufactured by only two dental floss holder elements, wherein the main and minor sections of the support plates, as well as the section of the longitudinal connecting element, are complimentary to form the whole dental floss holder when assembled. Similarly, the manufacture of an embodiment of a dental floss holder featuring eight lengths of dental floss will require four dental floss holder elements. In all embodiments, each dental floss holder element comprises two lengths 8, 8′ of dental floss arranged on opposite sides of the section of the longitudinal connecting element 1′, 1″, 1′″.

In use, a person may put the present dental floss holder into the mouth and the shape/form of the holder makes it easy to guide the dental floss between the teeth by a combination of chewing on the holder and moving it around by using the tongue. The size of the dental floss holder is such that it can be put into the mouth and used in a comfortable manner.

The dental floss holder according to the invention, excluding the lengths/strings of dental floss per se, may be manufactured in any suitable material, such as synthetic polymers having the required mechanical properties with regards to strength and flexibility/rigidity. A requirement of such materials is their suitability for oral use by humans. In view of the present disclosure, and known examples of materials used in prior art dental floss holders, the skilled person would easily find a number of materials fulfilling the required properties.

Preferably, the dental floss holder is manufactured in multiple connectable sections or elements by molding. In such manufacture, the attachment of the strings of dental floss may advantageously be performed during the molding process, or in a subsequent manufacturing step wherein the strings of dental floss are fastened by melting or gluing.

The dental floss holder according to the invention has a number of advantages over the prior art, including:
being more rigid—no bending as seen in prior art, both due to the increased inherent structural strength of the plate elements/connecting element combination and due to the opposing strings of dental floss.
easier to clean—no “nooks and crannies” in which food particles and similar may accumulate.
more easy to manufacture.
the plate elements gives a smooth and comfortable use in the mouth with no edges sticking out from the dental floss holder.
the two plate elements provide an excellent space for including the product logo or other information to the user.

1. A dental floss holder comprising a longitudinal connecting element, a first support plat, a second support plate, and at least four lengths of dental floss,
wherein the longitudinal connecting element comprises a first end and a second end;
wherein the first support plate is arranged at the first end of the longitudinal connecting section and has a first circumference;
wherein the second support plate is arranged at the second end of the longitudinal connecting section, opposite the first support plate, and has a second circumference; and
wherein the first and the second circumference are arranged such that each of the at least four lengths of dental floss is arranged on the dental floss holder, and
wherein each of the at least four lengths of dental floss extends from the first circumference to the second circumference.

2. The dental floss holder according to claim 1, wherein each of the at least four lengths of dental floss is arranged in parallel to the centerline of the longitudinal connecting element.

3. The dental floss holder according to claim 1, wherein each of the at least four lengths of dental floss is arranged on an opposite side of the longitudinal connecting element in relation to one of the other at least four lengths of dental floss.

4. The dental floss holder according to claim 1, wherein the centerline of the longitudinal connecting element is perpendicular to the plane of the first support plate and the second support plate.

5. The dental floss holder according to claim 1, wherein the centerline of the longitudinal connecting element intersects the center of symmetry of the first support plate and the second support plate, respectively.

6. The dental floss holder according to claim 1, wherein the first support plate and the second support plate comprises a first surface and a second surface, the first surfaces connected to the first and second end of the longitudinal connecting element, respectively, and the second surfaces comprises fastening means for the at least four lengths of dental floss.

7. The dental floss holder according to claim 5, wherein the fastening means for the at least four lengths of dental floss comprises a lid element arranged to releasably fasten a string of dental floss at the second surface.

8. The dental floss holder according to claim 1, wherein the first and the second circumference have a substantially circular or elliptic shape.

9. The dental floss holder according to claim 1, wherein each of the first and the second circumference comprises at least four recesses for accommodating the at least four strings of dental floss.

10. The dental floss holder according to claim 1, wherein the at least four lengths of dental floss are arranged in a first and a second pair, each pair comprising two lengths of dental floss arranged on opposite sides of the longitudinal connecting element, and the distance from longitudinal connecting element to the two lengths of dental floss in the first pair is larger than the corresponding distance to the second pair.

11. The dental floss holder according to claim 1, wherein the longitudinal connecting element is hourglass-shaped.

12. The dental floss holder according to claim 1, wherein the at least four lengths of dental floss are non-releasably fastened at the first and the second circumference.

13. A method of manufacturing a dental floss holder according to claim 12, comprising the steps of:
molding at least two connectable dental floss holder elements, each of the dental floss holder elements comprises a section of the first support plate, a section of the second support plate, a section of the longitudinal connecting element and two lengths of dental floss arranged on opposite sides of the section of the longitudinal connecting element;
assembling the at least two dental floss holder elements to provide the dental floss holder.

14. The method of manufacturing a dental floss holder according to claim 13, wherein a number of connectable dental floss holder elements is equal to half a number of lengths of dental floss in the dental floss holder.
